(19) United States
(12) Patent Application Publication
(10) Pub. No.: US 2005/0231598 A1
(43) Pub. Date: Oct. 20, 2005

(54) Digital camera module and a digital host device

(76) Inventors: Amit Dutta, Kanagawa-ken (JP); Kazunobu Shin, Tokyo-to (JP)

Correspondence Address: HARRINGTON & SMITH, LLP, 4 RESEARCH DRIVE, SHELTON, CT, 06484-6212, US

(21) Appl. No.: 10/498,399

(22) PCT Filed: Dec. 30, 2002
(86) PCT No.: PCT/IB02/05749

§ 371 Date: Jun. 23, 2005

(30) Foreign Application Priority Data
Nov. 8, 2002 (GB) 0226014.9

(51) Int. Cl. H04N 5/225

(52) U.S. Cl. 348/207.99

(57) ABSTRACT

A digital camera system is formed from a host device and a camera module. The host device has a user interface for receiving user input that controls the operation of a connected camera module and a first processor operable in response to user input via the user interface specifying a camera action, to create a request message. The camera module has image capturing means and a second processor operable to decode a request message to control the image capturing means. When the camera module is attached to the host device the first and second processors are connected for communication.

Embodiments of the present invention relate to a digital camera module and a digital host device.

Until recently, if a user of a digital device (e.g. computer, mobile phone, PDA etc.) also wanted to take digital photographs, the user would have had to use a separate dedicated digital still camera (DSC).

However, it is undesirable for the user to have to purchase and carry two separate dedicated digital devices. To address this problem, digital devices with integrated cameras have been developed and camera modules for attachment to digital devices have been developed.

However, the image quality and camera functionality provided by integrated cameras and camera modules is significantly less than that provided by a dedicated DSC. For example, for current camera modules for a mobile telephone the resolution is at most 350,000 pixels, whereas a DSC can now have a resolution of greater than 4 million pixels.

It is not possible to simply add more of the functionality from a DSC into a camera module as this will compromise the primary functionality of the digital device to which it is attached. The primary functionality of a digital device varies from device to device, but for a mobile phone it may be telecommunication functions.

It would therefore be desirable to enable a digital device to be used to take, higher quality images without compromising the primary function of the digital device.

According to one aspect of the present invention there is provided a digital camera system comprising: a user interface for receiving user input that controls the operation of a connected camera module; image capturing means; a first processor operable in response to user input via the user interface specifying a camera action, to create a request message; a second processor, connected to the first processor and operable to decode a request message to control the image capturing means, wherein the user interface, and the first processor are housed within a host digital device and the image capturing means and the second processor are housed within a camera module connected to the host digital device.

According to another aspect of the present invention there is provided a method of controlling a digital camera that comprises a host device and a camera module, comprising the steps of: providing user input at a host device; converting the user input, in the host device, to a request message; transferring the request message from the host device to the camera module; and converting the request message, in the camera module, to control signals for controlling image capture.

According to a further aspect of the present invention there is provided a camera module, for connection to a host digital device, comprising: an input interface; image capturing means; and a processor, collected to the input interface, operable to decode a request message and to produce control signals for directly controlling the image capturing means.

According to another aspect of the present invention there is provided a method of controlling the operation of a camera module comprising the steps of: receiving at the camera module a request message; converting the request message, in a processor of the camera module, to control signals for controlling image capture.

According to a further aspect of the present invention there is provided a host digital device, for connection to a camera module, comprising: a user interface for receiving user input that controls the operation of a connected camera module; an output interface for providing data to a connected camera module; an input interface for receiving image data from a connected camera module; and a processor operable in response to user input via the user interface specifying a camera action, to create a request message and to provide the request message to a collected camera module via the output interface.

According to another aspect of the present invention there is provided a method of controlling the operation of a camera module from a host device to which it is connected, comprising the steps of: providing user input at the host device; converting the user input, in the host device, to a request message; transferring the request message to the camera module.

According to a still further aspect of the present invention there is provided a computer program which when loaded into a host digital device enables a processor in the host digital device to communicate directly with a processor of an attached camera module using a message based protocol.

Thus in embodiments of the invention, the host device processor is decoupled from controlling the camera modules functions. The host device processor need not know how to control the workings of the camera module. It need only communicate using a message based protocol.

Thus in embodiments of the invention, the host device may be an existing host device with a software update. That is, no hardware modifications are required in the host.

The use of a separate dedicated processor in the camera module enables the operation of the camera module to be easily updated by changing or updating the software controlling the processor in the camera module. This will have no effect on the host device.

The use of a separate dedicated processor in the camera module enables process intensive tasks such as auto white balance, auto focusing and auto exposure without adding to the workload of the processor of the host.

According to one aspect of the present invention there is provided a clip-set for a camera module, comprising: a first input interface for receiving data from an image sensor; image processing means for processing data received via the first input interface; and a processor for controlling the image processing means.

According to another aspect of the present invention there is provided a method of controlling the operation of a camera module comprising the steps of: receiving at a camera module chip-set a request message; converting the request message, in processing means of the camera module chi-set, to control signals for controlling image capture.

For a better understanding of the present invention reference will now be made by way of example only to the accompanying drawings in which

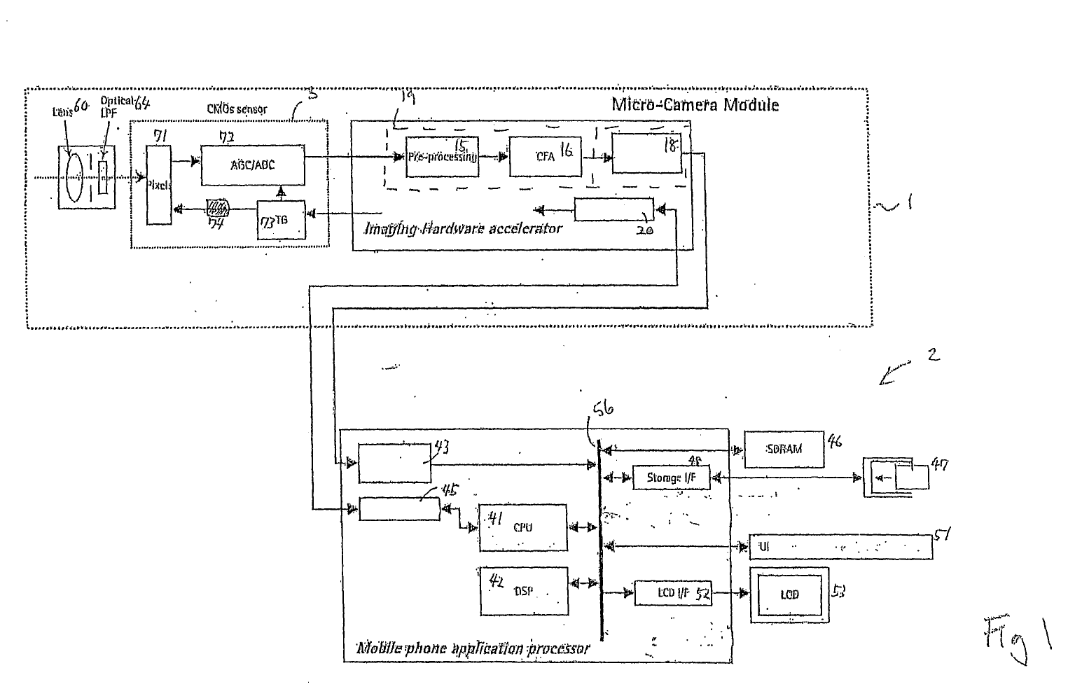

FIG. 1 illustrates a prior art host device and camera module combination;

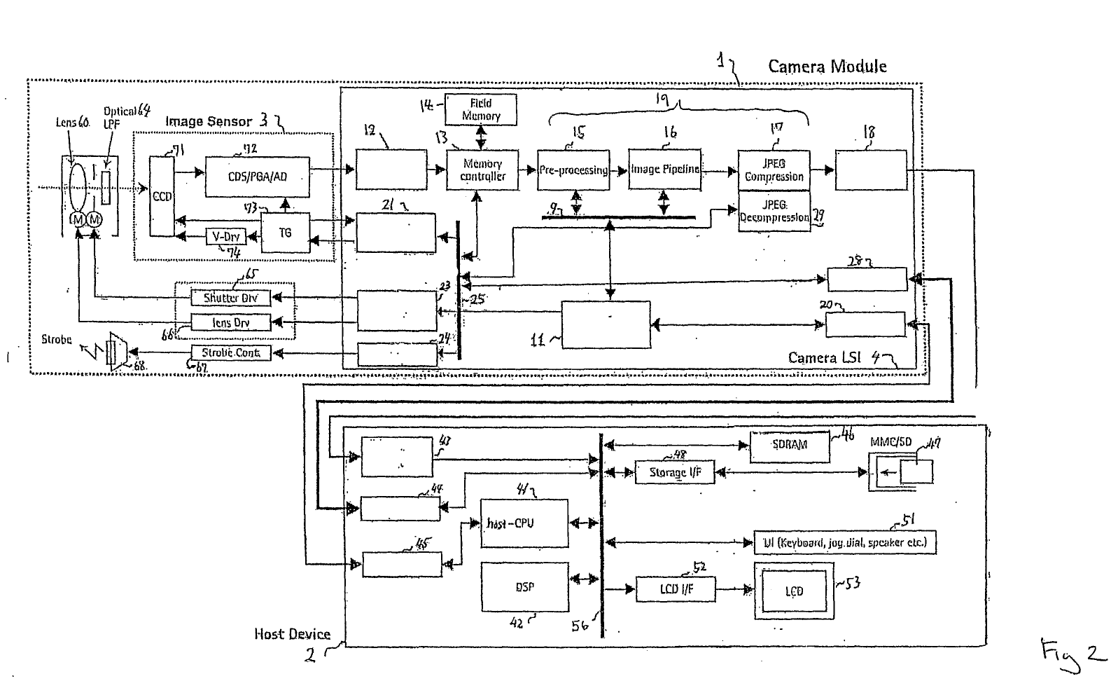

FIG. 2 illustrates a host device and camera module combination according to one embodiment of the present invention.

FIG. 1 illustrates a prior art digital device 2 hosting a prior art digital camera module 1. The digital camera module 1 comprises an input interface 20 and an output data interface 18 connected to the host 2. The input interface 20 is connected to provide an input signal to a CMOS image sensor 3. The CMOS image sensor receives light which has traveled through an optical lens system 60, and an optical filter 64, before reaching the image sensor 3. The image sensor 3 provides an output signal to an imaging hardware accelerator 19, which provides image data to the host 2 via the output data interface 18.

The imaging hardware accelerator is a pipeline structured hardwired signal processing apparatus. Data is processed stage by stage sequentially. It is fast, has a low power consumption and a small size. The image hardware accelerator comprises a pre-processing unit 15 and image pipeline 16. The pre-processing unit 15 processes data received from the image sensor 3 before it is reconstructed as an image by the image pipeline 16. This processing may, for example, include: defect correction, gain control or black level offset matching.

The host device 2 comprises an input data interface 43 that is connected to the camera module's output data interface 18 and an output interface 45 that is connected to the camera module's input interface 20. The connection between the interfaces is releasable.

A CPU 41 is connected to the output interface 45. The CPU 41 directly controls the CMOS image sensor 3 via the interfaces 45, 20. The CPU 41 writes directly to registers in a timing generator 73 in the image sensor 3.

A bus system 56 connects together the input data interface 43, the CPU 41, a memory 46, a removable storage system comprising a removable memory 47 and device interface 48, a user input interface 51, a display system comprising an LCD 53 and display device interface 52. In this embodiment the digital host device 2 is a mobile phone and also comprises a digital signal processing (DSP) unit 42.

The user interface 51 is used to provide inputs to the host CPU 41, which directly controls the camera module 1. The image data provided by the camera module 1 can be stored in the memory 46 or removable memory 47 or displayed on LCD 53 depending upon input from the user interface 51.

FIG. 2 illustrates a digital device 2 hosting a digital camera module 1, according to one embodiment of the present invention. The host device in this example is a mobile cellular telephone. However, in other implementations the host digital device 2 may be a computer, a personal digital assistant etc.

The Camera Module

The digital camera module 1 comprises a camera module chip-set 4, and camera hardware. The camera hardware includes a strobe system including a strobe interface controller and a strobe light 68, an image sensor 3 that receives light via an optical system and an opto-mechanical system. The optical system has, in order, an adjustable lens system 60, a variable optical aperture, a mechanical shutter and an optical filter 64. The opto-mechanical system comprises a lens driver 66 for controlling the positions of the lens in the lens system 60 and a shutter driver 65 that sets the speed of operation of the shutter and the size of the optical aperture. The camera chip-set has a strobe interface 24 that is connected to the strobe interface 67, a opto-mechanical interface 23 that is connected separately to the shutter driver 65 and the lens driver 66, a sensor control interface 21 that is connected to the timing gate of the image sensor 3, and a sensor data interface 12 for receiving data from the image sensor 3.

Each of the sensor control interface 21, opto-mechanical interface 23 and strobe interface 24 are connected to a bus system 25.

The sensor data interface 12 is connected to a data type converter that also includes a memory controller 13 and a field memory 14. The data type converter is connected to an imaging hardware accelerator 19, which provides image data to the host 2 via an output data interface 18.

Imaging hardware accelerator 19 comprises, in order, a pre-processing unit 15, an image pipeline 16 and a data compressor 17.

The camera chipset 4 also has an input interface 20 for receiving data from the host 2. The input interface 20 is connected to camera module CPU 11. The camera module CPU 11 is connected to a bus system 9 that connects separately to the pre-processing unit 15 and the image pipeline 16 of the imaging hardware accelerator 19. The camera module CPU 11 also connects to the bus system 25.

How the Camera Module Works

The camera module CPU 11 is able to directly control the image processing stages via the bus 9. The CPU 11 is able to directly control the image capture stages via the bus system 25 using:
a) The strobe interface 24;
b) The opto-mechanical interface 23;
c) The sensor control interface 21.

The CPU 11 may for example specify if a strobe should be used via the strobe interface 24.

The CPU 11 may for example specify by how much a lens should be moved by how much an IRIS aperture should be increased or decreased or control the shutter speed via the opto-mechanical interface 23. The CPU 11 will generally write directly to registers in the optical system.

The CPU 11 may for example control the operation of the image sensor 3 via the sensor control interface 21. For example, if the image sensor apparatus 3 is a CCD sensor unit comprising CCD sensor array 71 and Timing Generator 73, the CPU 11 may send commands to clear CCD charge or to change parameters of the timing generator 73.

The image sensor 3 receives light which has traveled through the configurable optical lens system 60, a configurable optical aperture and an optical filter 64, before reaching the image sensor 3. The image sensor provides an output data signal to a configurable imaging hardware accelerator 19, via the data type converter. The imaging accelerator 19 provides compressed image data to the host 2 via the output data interface 18. The CPU 11 sends command signals directly to the camera hardware (lens system 60, aperture, mechanical shutter, strobe 68 and image sensor 3) and the imaging accelerator 19 optics to configure them.

In this example the image sensor 3 is a charge couple device (CCD) image sensor.

It comprises a charge coupled device array 71 that provides an output via an analogue to digital converter (ADC) 72 to the sensor data interface 12 of the camera module chip-set 4. The CCD array 71 and the ADC 72 are synchronized by a timing generator 73. The timing gate also controls the CCD array through driver 74. The timing gate 73 is connected to the sensor control interface 21 of the camera module chip-set 4. The CPU 11 is able to directly control the operation of the image sensor 3.

In this example, the CCD array 71 operates in an interlaced and not a progressive fashion and the imaging accelerator is optimized for working on data from a progressive image sensor. The image sensor data provided to the sensor data interface 12 is converted from an interlaced format to a progressive format by the data type converter. The data in interlaced format is read to field memory 14 by the memory controller 13, and then read from the field memory 14 in a progressive format by the memory controller and provided to the imaging accelerator 19. If the image sensor 3 was a CMOS image sensor or a progressive CCD image sensor, the data type converter need not be present, or if present, need not be used. The CPU 11 may interrogate the image sensor 3 during initialization to determine what type of image sensor it is and configure its operation accordingly, including but not limited to whether or not the data type converter is used.

The imaging accelerator 19 receives data in a progressive format. The pre-processing unit 15 processes this data before it is reconstructed as an image. These processes may include: (a) defect correction, (b) gain control (c) black level offset matching.

The image pipeline 15, then reconstructs the processed data as image data. It performs three types of processes:
1) Image reconstruction normally by CFA interpolation.
2) Color space conversion, which means, converting color space from RGB to YUV.
3) Post-processing, which typically includes (a) white balancing, (b) Gamma controlling, (c) Edge enhancement.

The data compressor 17 compresses the image data using JPEG or JPEG2000 compression and provided the compressed image data to the output data interface 18.

The pre-processing unit 15 and the image pipeline 16 provide inputs to the CPU 11 via the bus system 9. The inputs provided by the imaging accelerator 19 may include:
(i) Contrast information,
(ii) Brightness information,
(iii) The hardware status (the values of internal register). In other embodiment, this information is provided from the sensor data interface 12.

The CPU 11 processes these inputs in accordance to a stored algorithm to create command signals. These are sent to the camera hardware to control the image capture stage and to the image accelerator 19 to control the image processing stage. A feed-back loop may therefore be created, whereby the CPU 11 varies the camera hardware settings which varies the data provided to the imaging accelerator 19 which varies the inputs to the CPU 11. The CPU 11 is therefore able to determine if the opto-mechanics are set correctly and, if not, it sends command signals to the opto-mechanics to adjust settings via the opto-mechanics interface 23. A command signal may control the movement of the lens by 0.2 mm, for example.

The CPU 11 may perform auto aperture adjustment. The CPU calculates appropriate aperture size and shutter speed from the inputs, and sends command signals via the opto-mechanical interface 23 to set the aperture size and shutter speed and also, if necessary, it sends command signals via the strobe interface 24 to set the strobe 68 to be prepared to flash.

The CPU 11 may also control optical-zoom function.

The CPU 11 may perform auto focusing. The CPU 11 analyzes the inputs from the imaging accelerator 19, calculates the appropriate lens position, and sends command signals via the opto-mechanical interface 23 to set lenses in the calculated positions.

The camera-CPU may set the imaging accelerator. The camera-CPU analyzes the inputs (brightness and contrast of the environment), and sends a command signal to set a filter of the imaging accelerator 19 to an appropriate setting. This adjusts the manner in which images are reconstructed e.g. to obtain appropriate white balance. The CPU 11 may therefore provide auto white-balance in the image data.

The CPU 11 may adjust the compression algorithm used by the compressor.

It should therefore be appreciated that the CPU 11 can control the camera hardware through various interfaces and can control the hardwired imaging accelerator 19. The CPU 11 does not, however, play any part in processing image data. The imaging accelerator processes the image data.

The Host Device

The host device 2 comprises an input data interface 43 that is connected to the camera module's output data interface 18 and an output control interface 45 that is connected to the camera module's input interface 20. The connection between the interfaces is releasable.

A host CPU 41 is connected to the output control interface 45. A bus system 56 connects together the input data interface 43, the host CPU 41, a memory 46, a removable storage system comprising a removable storage 47 and device interface 48, a user input interface 51, a display system comprising an LCD 53 and display device interface 52. In this embodiment the digital host device 2 is a mobile phone and also comprises a digital signal processing (DSP) unit 42 which connects the bus system 56 to a cellular radio transceiver 40. In other embodiments, the digital host device may be a computer or a portable digital host such as a personal digital assistant (PDA) or a mobile computer.

The user interface 51 is used to provide inputs to the host CPU 41. These are generally used to control the primary functions of the host 2, such as making mobile telephone calls, however, when the camera module 1 is attached they can also be used to control the camera module operation. The image data provided by the camera module 1 can be stored in the memory 46 or removable storage 47 or displayed on LCD 53 depending upon input from the user interface 51.

The memory 46, removable storage 47, user interface 51 and LCD 53 of the host 2 are used to provide camera functionality when the camera module 1 is attached. The camera module chip-set 4 does not need a large dedicated memory as the memory of the host is used for data storage.

No hardware component changes in the host are mandated by embodiments of the present invention compared with the prior art host 2 of FIG. 2. The operation of the host 2 is, however, different. This change in functionality may be achieved by changing the host device's software. It may be possible to up-grade existing hosts to be used in embodiments of the present invention by updating their software. Such an update may be provided by loading a computer program from a storage medium into the host device or downloading a program into the host device 2.

Message Based Architecture

The software change to the host causes it to indirectly, as opposed to directly, control the camera module 1 using a message based protocol between the host CPU 41 and the camera CPU 11 that specifies actions that are to be taken but not how they are to be implemented. The CPU 11 of the camera module 1 is used to produce the command signals for controlling the camera hardware and implementing the camera functions, the host CPU 41 of the host is no longer used to create command signals. The actions specified by a request message may include, for example, prepare to take a picture, take a picture, zoom-in, zoom-out, store an image, display an image etc.

The CPU 11 has its own operating system and software. The CPU 11 implements the settings in the camera hardware and the imaging accelerator 19. These settings are calculated by the software algorithm based upon inputs from the imaging accelerator 19 and the action that is to be carried out e.g. zoom, prepare to take picture, take picture etc. The CPU 11 does not itself specify the action. The action is specified by the host CPU 41 of the host device. The specified function is communicated to the CPU 11 in a request message that is sent via the output interface of the host 2 to the input interface 20 of the camera module 1. The camera module CPU 11 decodes the request message specifying an action, determines what functions are required to achieve this action and produces command signals for implementing the necessary camera functions.

The host CPU 41 is therefore unconcerned about how to implement a particular function, it merely interprets inputs received via the user interface 51 to create a message that specifies a particular action or action. The messages have a standardized format that is understood by the camera CPU 11 and the host CPU 41. The host CPU 41 therefore has no direct control over the camera hardware. It controls it indirectly via the camera-CPU 11.

The camera CPU 11 implements the functions required to carry out an action specified by received message, intelligently according to its software algorithm by sending command signals to the camera hardware and/or imaging accelerator 19. These functions may involve auto focusing, auto exposure, lens movement for optical zoom, strobe control, image sensor control and image accelerator control.

The host device need not know what functions the camera can perform, how to combine certain functions to achieve an action, or how to control the camera components to implement a function.

The camera module can be simply upgraded by upgrading the software algorithm used by the CPU 11. There is no need to update the software of the host device 2.

Description of Process

When a user uses the user interface 51 to indicate that (s)he may want to take a picture, the host CPU 41 sends a message specifying “prepare for taking a picture” to the camera module CPU 11. The CPU 11 controls the settings for capturing and processing an image. At first the CPU 11 acquires brightness and contrast information of the environment from pre-processing unit through bus-system 9. CPU 11 analyzes these information in accordance with the algorithm, and calculates the amount of lens movement for clear focusing, shutter speed and aperture size for appropriate exposure, setting of image accelerator 19 for appropriate white balance. Then the CPU 11 produces the appropriate control signals to the opto-mechanical interface 23, the strobe interface 24, the sensor control interface 21 and the image accelerator 19. Thus the CPU 11 controls auto-focusing, shutter speed, auto-exposure, whether to flash the strobe or not, and appropriate lens position for required zoom. After the Camera-CPU 11 has achieved the appropriate settings it sends a reply message to the host CPU 41 to notify it. It may also send image data so that an image can be displayed on LCD 53.

When a user uses the user interface 51 to indicate that (s)he wants to take a picture, the host CPU 41 sends a message specifying “take a picture” to the camera module CPU 11. It may also specify the picture quality and where the image should be saved (i.e. internal memory 46 or removable memory 47). The camera-CPU 11 decodes the received message and takes necessary actions. The camera-CPU 11 may set parameters (e.g., gain or data acquiring mode) of timing gate (TG) 73 and driver 74 of image sensor unit 3 through sensor control interface 21. Or the camera-CPU 11 may change the compression rate by changing parameters of data compressor 17. The camera-CPU 11 then controls the camera hardware to take a picture. The captured data is processed through the data-type converter (if necessary) and the imaging accelerator 19 of the camera chip-set before being sent to the host for storage in the memory 46.

In one embodiment, when a user wishes to display a stored image, the image data is transferred from removable memory 47 to memory 46 (if necessary), and processed by host CPU 41 and DSP unit 42 and displayed on LCD 53. In this embodiment the replay is controlled by the host-CPU 41 and camera module 1 does not do anything. Thus the display of an image may be achieved without attaching a camera module 1.

In another embodiment when a user wishes to display a stored image, the camera module chip-set 4 controls the display of the stored image. The camera module additionally comprises a data de-compressor 29 associated with the data compressor 17 and a serial interface 28. The data decompressor 29 and serial interface 28 are interconnected via the bus system 25, which is also connected to memory controller 13. The host device 2 additionally has a serial interface 44 that connects with the serial interface 28 of the camera module 1.

The host CPU 41 transfers image data from removable memory 47 to memory 46 (if necessary) and then transmits to through serial interface 44 to the serial interface 28 of the camera module 1. The received image data is stored temporarily in the field memory 14 via the bus system 25 by the CPU 11. The CPU 11 then transfers it to decompressor 29 via the bus system 25 for decompression and then transmits it through the serial interface 28 to the serial interface 44 of the host 2 where it is displayed on LCD 53.

Although embodiments of the present invention have been described in the preceding paragraphs with reference to various examples, it should be appreciated that modifications to the examples given can be made without departing from the scope of the invention as claimed. For example, the CCD image sensor 3 may be replaced by a CMOS image sensor.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A digital camera system comprising:
a user interface for receiving user input that controls the operation of a connected camera module; image capturing means;
a first processor operable in response to user input via the user interface specifying a camera action, to create a request message;
a second processor, connected to the first processor and operable to decode a request message to control the image capturing means,
wherein
the user interface, and the first processor are housed within a host digital device and the image capturing means and the second processor are housed within a camera module connected to the host digital device.

2. A digital camera system as claimed in claim 1, wherein the first processor in the host digital device and the second processor in the camera module are arranged to communicate directly using a message based protocol, whereby the second processor directly controls the image capturing means and the host device only indirectly controls the image capturing means via the second processor.

3. A digital camera system as claimed in claim 1, further comprising image processing means housed within the camera module for processing data provided by the image capturing means to create image data, wherein the second processor is operable to decode a request message to control the image processing means and the image capturing means.

4. A digital camera system as claimed in claim 1, wherein the first processor in the host digital device and the second processor in the camera module are arranged to communicate directly using a message based protocol, whereby the second processor directly controls the image capturing means and image processing means and the host device only indirectly controls the image capturing means and image processing means via the second processor.

5. A digital camera system as claimed in claim 1, further comprising a removable memory for storing image data that has been created under the control of the second processor, wherein the removable memory is housed in the host digital device.

6. A digital camera system as claimed in claim 1, further comprising a memory for storing image data that has been created under the control of the second processor, wherein the memory is housed in the host digital device.

7. A digital camera system as claimed in claim 1, further comprising
a display for displaying images captured by the image capturing means, wherein the display is housed in the host digital device.

8. A digital camera system as claimed in claim 7, wherein the camera module is arranged to compress image data to create compressed image data and the digital host device is arranged to decompress compressed image data to recover image data for display on the display.

9. A digital camera system as claimed in claim 7, wherein the camera module is arranged to compress image data to create compressed image data and the digital host device is arranged to provide compressed image data to the camera module and to receive in reply decompressed image data for display on the display.

10. A digital camera system as claimed in claim 1, wherein the camera module is attachable to and detachable from the host digital device.

11. A digital camera system as claimed in claim 1, wherein a request message specifies a camera action.

12. A method of controlling a digital camera that comprises a host device and a camera module, comprising the steps of:
providing user input at a host device;
converting the user input, in the host device, to a request message;
transferring the request message from the host device to the camera module; and
converting the request message, in the camera module, to control signals for controlling image capture.

13. A camera module, for connection to a host digital device, comprising:
an input interface;
image capturing means; and
a processor, connected to the input interface, operable to decode a request message and to produce control signals for directly controlling the image capturing means.

14. A camera module as claimed in claim 13, further comprising image processing means wherein the processor is operable to decode a request message and produce control signals for directly controlling the image capturing means and the image processing means.

15. A camera module as claimed in claim 14, wherein the image processing means provides an input or inputs to the processor.

16. A camera module as claimed in claim 15, wherein the input(s) are indicative of the brightness and the contrast of an image.

17. A camera module as claimed in claim 14, wherein the image processing means comprises a configurable hardwired imaging accelerator.

18. A camera module as claimed in claim 13, wherein the processor is operable to produce a control signal for setting the configuration of the image capturing means.

19. A camera module as claimed in claim 18, wherein the processor is operable to produce a control signal for setting the configuration of camera opto-mechanics.

20. A camera module as claimed in claim 19, wherein the camera opto-mechanics comprise lens position, aperture size and shutter speed.

21. A camera module as claimed in claim 18, wherein the processor is operable to produce a control signal for setting the configuration of a strobe.

22. A camera module as claimed in claim 18, wherein the processor is operable to produce a control signal for setting the configuration of an image sensor.

23. A camera module as claimed in claim 13, wherein the processor provides auto-focusing.

24. A camera module as claimed in claim 13, wherein the processor provides auto-exposure.

25. A camera module as claimed in claim 13, wherein the processor provides an optical zoom function.

26. A camera module as claimed in claim 13, wherein the processor provides an auto white balance function.

27. A camera module as claimed in claim 13, wherein the processor operates in accordance with a computer program that may be varied or replaced.

28. A camera module as claimed in claim 13, wherein the image capturing means comprises a CCD image sensor.

29. A camera module as claimed in claim 13, further comprising conversion means for converting interlaced type data from the image capturing means to progressive type data.

30. A camera module as claimed in claim 13, wherein the processor is arranged to display image data only by transferring it to an attached host device.

31. A camera module as claimed in claim 13, wherein the processor is arranged to store image data only by transferring it to an attached host device.

32. A camera module as claimed in claim 13, arranged to compress image data to create compressed image data.

33. A camera module as claimed in claim 13, wherein the camera module is arranged to compress image data to create compressed image data for transfer to a connected host device and to decompress compressed image data received from an attached host device to produce decompressed image data.

34. A camera module as claimed in claim 13, wherein a request message specifies a camera action.

35. A method of controlling the operation of a camera module comprising the steps of:
receiving at the camera module a request message;
converting the request message, in a processor of the camera module, to control signals for controlling image capture.

36. A host digital device, for connection to a camera module, comprising:
a user interface for receiving user input that controls the operation of a connected camera module;
an output interface for providing data to a connected camera module;
an input interface for receiving image data from a connected camera module; and
a processor operable in response to user input via the user interface specifying a camera action, to create a request message and to provide the request message to a connected camera module via the output interface.

37. A host device as claimed in claim 36, wherein a request message specifies a camera action.

38. A host device as claimed in claim 36, wherein the processor is arranged to communicate directly with a processor of an attached camera module using a message based protocol.

39. A host digital device as claimed in claim 36, further comprising:
a removable memory for storing image data that has been captured and processed under the control of the camera module.

40. A host digital device as claimed in claim 36, further comprising: a memory for storing image data that has been captured and processed under the control of the camera module.

41. A host device as claimed in claim 36, further comprising a display for displaying an image captured by an attached camera module.

42. A host device as claimed in claim 41, further arranged to decompress compressed image data to recover image data for displaying an image on the display.

43. A host device as claimed in claim 41, wherein the processor is arranged to provide compressed image data to a connected camera module and to receive in reply decompressed image data for displaying an image on the display.

44. A method of controlling the operation of a camera module from a host device to which it is connected, comprising the steps of:
providing user input at the host device;
converting the user input, in the host device to a request message;
transferring the request message to the camera module.

45. A computer program comprising program instructions which when executed cause a computer to operate as a host device as claimed in claim 36.

46. A computer program comprising program instructions for causing a computer to perform the method of claim 44.

47. A computer program which when loaded into a host digital device enables a processor in the host digital device to communicate directly with a processor of an attached camera module using a message based protocol.

48. A computer program as claimed in claim 47, embodied a record medium or stored in a computer memory.

49. (canceled)

50. (canceled)
